(19) United States
(12) Patent Application Publication
(10) Pub. No.: US 2022/0343449 A1
(43) Pub. Date: Oct. 27, 2022

(54) RIDE SHARING SYSTEMS AND METHODS FOR PROVIDING ROUTE RECOMMENDATIONS

(71) Applicant: Toyota Motor Engineering & Manufacturing North America, Inc., PLANO, TX (US)

(72) Inventors: Nejib Ammar, San Jose, CA (US); Akila C. Ganlath, Agua Dulce, CA (US); Prashant Tiwari, Santa Clara, CA (US)

(73) Assignee: Toyota Motor Engineering & Manufacturing North America, Inc., PLANO, TX (US)

(21) Appl. No.: 17/236,114

(22) Filed: Apr. 21, 2021

(51) Int. Cl. G06Q 50/30; G06Q 30/06; G01C 21/36

(52) U.S. Cl. CPC G06Q 50/30; G06Q 30/0621; G01C 21/36

(57) ABSTRACT

A ride sharing method is disclosed including receiving, from a user device, a user ride request at a primary mobility service provider, the primary mobility service provider monitoring activity of vehicles registered with the primary mobility service provider, transmitting, by the primary mobility service provider, the user ride request to one or more secondary mobility service providers, each secondary mobility service provider monitoring activity of vehicles registered with the secondary mobility service provider, identifying, by the primary mobility service provider, a primary route recommendation, receiving, at the primary mobility service provider, one or more secondary route recommendations from the one or more secondary mobility service providers, and presenting the primary route recommendation and the one or more secondary route recommendations to the user device.

### TECHNICAL FIELD

The present specification generally relates to ride sharing systems and methods for providing route recommendations to a user and, more specifically, ride sharing systems and methods for providing route recommendations that include vehicles across different mobility service providers.

### BACKGROUND

App-based ride sharing services have proven to be an efficient and convenient door-to-door mobility solution. Pooled ride sharing services, such as those that assign multiple passengers to a single vehicle at the same time, are particularly attractive in comparison to private ride sharing services in which only a single user is assigned to a vehicle at any one time due to its better use of the vehicle and road recourses with relatively less traffic congestion, as well as reduction of mobility costs and emissions footprint. However, in either case, a user may be assigned to a vehicle or to a vehicle that already includes a passenger that does not meet the user's particular preferences. In addition, currently available ride sharing services are limited to only searching for vehicles registered with that particular ride sharing service, rather than matching the user with vehicles registered with other mobility service providers. Thus, the user is presented with a route provided by the particular ride sharing service from which the user is requesting a ride, rather than any other potential route available to a different ride sharing service provider.

Accordingly, a need exists for improved ride sharing systems that search across multiple databases of ride sharing vehicles of different mobility service providers to provide a plurality of route recommendations to a user.

### SUMMARY

In one embodiment, a method includes receiving, from a user device, a user ride request at a primary mobility service provider, the primary mobility service provider monitoring activity of vehicles registered with the primary mobility service provider, transmitting, by the primary mobility service provider, the user ride request to one or more secondary mobility service providers, each secondary mobility service provider monitoring activity of vehicles registered with the secondary mobility service provider, identifying, by the primary mobility service provider, a primary route recommendation, receiving, at the primary mobility service provider, one or more secondary route recommendations from the one or more secondary mobility service providers, and presenting the primary route recommendation and the one or more secondary route recommendations to the user device.

In another embodiment, a primary mobility service provider including a controller configured to monitor activity of vehicles registered with the primary mobility service provider, receive, from a user device, a user ride request at the primary mobility service provider, transmit the user ride request to one or more secondary mobility service providers, each secondary mobility service provider monitoring activity of vehicles registered with the secondary mobility service provider, identify a primary route recommendation, receive one or more secondary route recommendations from the one or more secondary mobility service providers, and present the primary route recommendation and the one or more secondary route recommendations to the user device.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an illustrative embodiment of a ride sharing system including a plurality of mobility service providers identifying vehicles and locations on a map, according to one or more embodiments shown and described herein;

FIG. 2 schematically depicts components of the ride sharing system including a primary mobility service provider and a secondary mobility service provider, according to one or more embodiments shown and described herein;

FIG. 3 schematically depicts a diagram of a controller of the primary mobility service provider of FIG. 2, according to one or more embodiments shown and described herein;

FIG. 4 schematically depicts an illustrative embodiment of the ride sharing system including the primary mobility service provider and a plurality of secondary mobility service providers, according to one or more embodiments shown and described herein;

FIG. 5 schematically depicts an illustrative table of details of a user ride request and supplemental details of an augmented user ride request, according to one or more embodiments shown and described herein;

FIG. 6 schematically depicts a diagram of a controller of the secondary mobility service provider of FIG. 2, according to one or more embodiments shown and described herein; and

FIG. 7 schematically depicts a flowchart of an illustrative method for determining one or more primary route recommendations and one or more secondary route recommendations, according to one or more embodiments shown and described herein.

### DETAILED DESCRIPTION

Embodiments described herein are directed to ride sharing systems and methods for determining route recommendations for a user based on available vehicles across a plurality of mobility service providers.

The methods for determining route recommendations include receiving a user ride request at a primary mobility service provider, transmitting the user ride request to one or more secondary mobility service providers, identifying a primary route recommendation, receiving one or more secondary route recommendations from the one or more secondary mobility service providers, and presenting the primary route recommendation and the one or more secondary route recommendations to the user device.

Various embodiments of the systems and methods and the operation of the systems are described in more detail herein. Whenever possible, the same reference numerals will be used throughout the drawings to refer to the same or like parts.

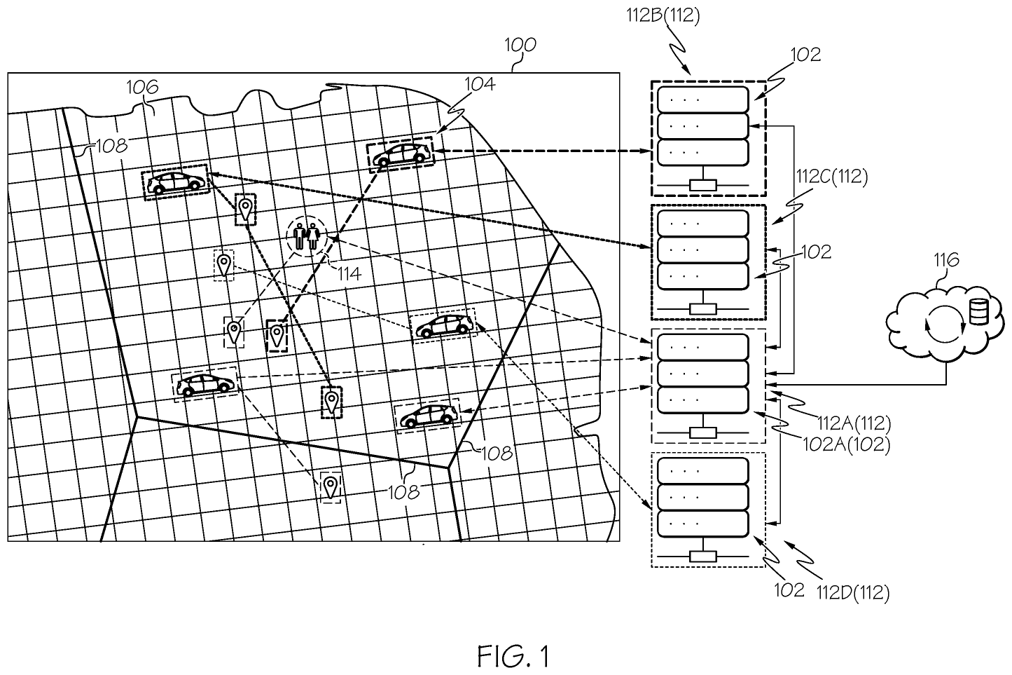

Referring now to FIG. 1, a schematic diagram of a map 100 and a plurality of servers 102 for monitoring activity of registered vehicles 104 within a predefined geographic region 106 is generally illustrated according to one or more embodiments described herein. Specifically, a plurality of boundary lines 108 are illustrated on the map 100. In the particular exemplary embodiment illustrated, the boundary lines 108 define individual geographic regions, such as the geographic region 106, in which a plurality of registered vehicles 104 are monitored in real time. In embodiments, the servers 102 monitor users, specifically, user devices registered to the users, within the geographic region. More particularly, it should be appreciated that the present disclosure is directed to a ride sharing system 110 in which a plurality of different mobility service providers 112 cooperate to provide a user with one or more route recommendations based on the availability of registered vehicles 104. Each mobility service provider 112 monitors its own database of registered vehicles and registered users. As used herein, the term “mobility service provider” refers to any ride sharing service, either presently available or soon-to-be available, such as, for example, Uber, Lyft, Via, Gett, Curb, and the like. Each mobility service provider 112 monitors vehicles and user activity of those vehicles and users registered with that particular mobility service provider 112.

As shown in FIG. 1, a primary mobility service provider 112A is illustrated and includes one or more servers 102A such as, for example, edge servers, for monitoring inputs from registered vehicles and registered users. Particularly, FIG. 1 illustrates that the primary mobility service provider 112A identifies a user ride request 114, as indicated on the map 100. As discussed in more detail herein, the primary mobility service provider 112A communicates with secondary mobility service providers 112B, 112C, 112D to provide a user-tailored listing of route recommendations to the user that initiated the user ride request 114. In embodiments, the primary mobility service provider 112A communicates with a central server 116, such as a cloud server, associated with the primary mobility service provider 112A. The central server 116 is utilized to store data collected by the primary mobility service provider 112A such as, for example, user profiles and the like. In addition, any of the processes, as discussed in more detail herein, being performed by the primary mobility service provider 112A may additionally or alternatively be performed at the central server 116 and transmitted back to the primary mobility service provider 112A.

FIG. 1 also illustrates a plurality of secondary mobility service providers 112B-112D, each including one or more servers 102 such as, for example, edge servers, for monitoring inputs from vehicles and users registered with that particular secondary mobility service provider 112B-112D. As shown, three secondary mobility service providers 112B-112D are illustrated. However, the ride sharing system 110 may include any number of secondary mobility service providers 112B-112D. As depicted in the figures, the primary mobility service provider 112A may be indicated by MSP 0 and the secondary mobility service providers 112B-112D may be indicated by MSP 1, MSP 2, MSP 3, respectively. As indicated by arrows and discussed in more detail herein, each of the secondary mobility service providers 112B-112D communicates with the primary mobility service provider 112A such that vehicle information and user information may be shared among the different mobility service providers, or at least with the primary mobility service provider 112A. By assigning the servers 102 of each of the primary mobility service provider 112A and the secondary mobility service providers 112B-112D to the predefined geographic region 106, the required time and processing power required to analyze data related to the registered vehicles and registered users is less than that required by processing additional information outside of the geographic region 106 that may be unnecessary for the specific user ride request 114 received from within the particular geographic region 106.

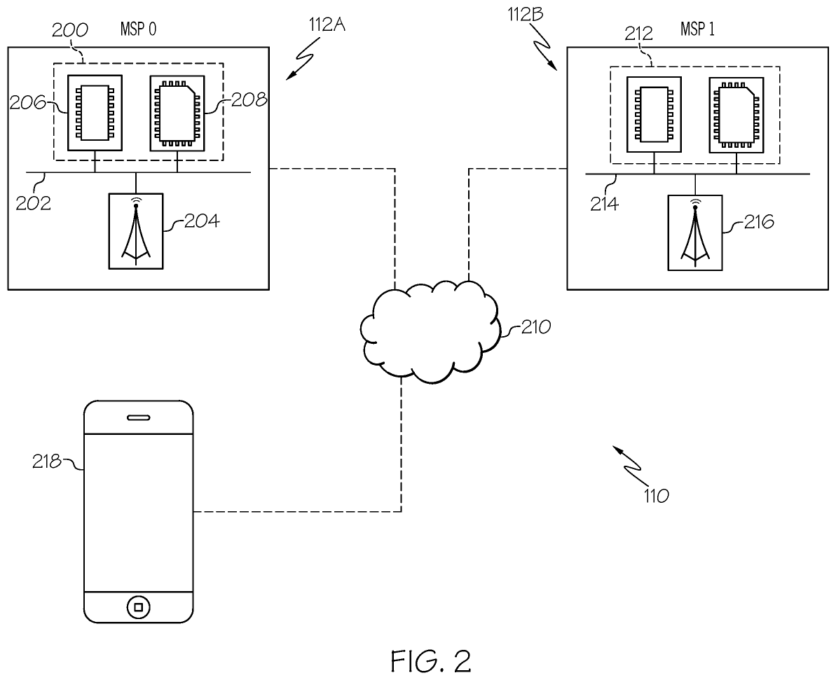

Referring now to FIG. 2, a schematic diagram of the ride sharing system 110 is depicted illustrating individual hardware components of the primary mobility service provider 112A and a secondary mobility service provider 112B. Although only the secondary mobility service provider 112B is illustrated, it should be appreciated that subsequent secondary mobility service providers may be provide and may include the same structure and components as the secondary mobility service provider 112B.

In embodiments, the primary mobility service provider 112A includes a controller 200, a communication path 202, and network interface hardware 204. The communication path 202 may be formed from any medium that is capable of transmitting a signal such as, for example, conductive wires, conductive traces, optical waveguides, or the like. Moreover, the communication path 202 may be formed from a combination of mediums capable of transmitting signals. In one embodiment, the communication path 202 includes a combination of conductive traces, conductive wires, connectors, and buses that cooperate to permit the transmission of electrical data signals to components such as processors, memories, sensors, input devices, output devices, and communication devices. Accordingly, the communication path 202 may include a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. The communication path 202 communicatively couples the various components of the primary mobility service provider 112A. As used herein, the term “communicatively coupled” means that coupled components are capable of exchanging data signals with one another such as, for example, electrical signals via conductive medium, electromagnetic signals via air, optical signals via optical waveguides, and the like.

As noted above, the primary mobility service provider 112A includes the controller 200 including the one or more processors 206 and one or more memory modules 208. Although not illustrated in FIG. 2, it should be appreciated that the controller 200 communicates with the servers 102A of the primary mobility service provider 112A illustrated in FIG. 1. Each of the one or more processors 206 may be any device capable of executing machine readable instructions. Accordingly, each of the one or more processors 206 may be an integrated circuit, a microchip, a computer, or any other computing device. The one or more processors 206 are communicatively coupled to the other components of the primary mobility service provider 112A by the communication path 202. Accordingly, the communication path 202 may communicatively couple any number of processors with one another, and allow the modules coupled to the communication path 202 to operate in a distributed computing environment. Specifically, each of the modules may operate as a node that may send and/or receive data.

Each of the one or more memory modules 208 of the primary mobility service provider 112A is coupled to the communication path 202 and communicatively coupled to the one or more processors 206. The one or more memory modules 208 may include RAM, ROM, flash memories, hard drives, or any device capable of storing machine readable instructions such that the machine readable instructions may be accessed and executed by the one or more processors 206. The machine readable instructions may include logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable instructions and stored on the one or more memory modules 208. In some embodiments, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

As noted above, the primary mobility service provider 112A includes the network interface hardware 204 for communicatively coupling the primary mobility service provider 112A with the secondary mobility service provider 112B, as well as the other secondary mobility service providers 112C, 112D (FIG. 1), via a network 210 such as, for example, the central server 116 (FIG. 1). The network interface hardware 204 is coupled to the communication path 202 such that the communication path 202 communicatively couples the network interface hardware 204 to other modules of the primary mobility service provider 112A. The network interface hardware 204 may be any device capable of transmitting and/or receiving data via a wireless network. Accordingly, the network interface hardware 204 may include a communication transceiver for sending and/or receiving data according to any wireless communication standard. For example, the network interface hardware 204 may include a chipset (e.g., antenna, processors, machine readable instructions, etc.) to communicate over wireless computer networks such as, for example, wireless fidelity (Wi-Fi), WiMax, Bluetooth®, IrDA, Wireless USB, Z-Wave, ZigBee, or the like. In some embodiments, the network interface hardware 204 includes a Bluetooth® transceiver that enables the primary mobility service provider 112A to exchange information with a mobile device such as, for example, a smartphone, via Bluetooth® communication.

The network 210 may include one or more computer networks (e.g., a personal area network, a local area network, or a wide area network), cellular networks, satellite networks and/or a global positioning system and combinations thereof. Accordingly, the primary mobility service provider 112A can be communicatively coupled to the network 210 via a wide area network, via a local area network, via a personal area network, via a cellular network, via a satellite network, etc. Suitable local area networks may include wired Ethernet and/or wireless technologies such as, for example, wireless fidelity (Wi-Fi). Suitable personal area networks may include wireless technologies such as, for example, IrDA, Bluetooth®, Wireless USB, Z-Wave, ZigBee, and/or other near field communication protocols. Suitable cellular networks include, but are not limited to, technologies such as LTE, WiMAX, UMTS, CDMA, and GSM.

Still referring to FIG. 2, the secondary mobility service provider 112B includes a controller 212, a communication path 214, and network interface hardware 216. The components of the secondary mobility service provider 112B may be structurally similar to and have similar functions as the corresponding components of the primary mobility service provider 112A (e.g., the controller 200 corresponds to the controller 212, the communication path 202 corresponds to the communication path 214, and the network interface hardware 204 corresponds to the network interface hardware 216).

As shown in FIG. 2, a user device 218 such as, for example, a cell phone tablet, or other personal computing device, is illustrated for transmitting the user ride request 114 (FIG. 1) to the primary mobility service provider 112A. Prior to transmitting the user ride request 114, the user device 218 is registered with the primary mobility service provider 112A and a user profile is established such that the primary mobility service provider 112A identifies ride preferences for the particular user. As discussed in more detail herein, the user device 218 communicates with the primary mobility service provider 112A to receive route recommendations collected from the primary mobility service provider 112A and the secondary mobility service providers 112B-112D.

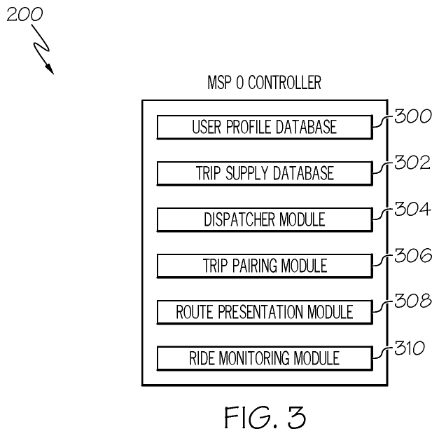

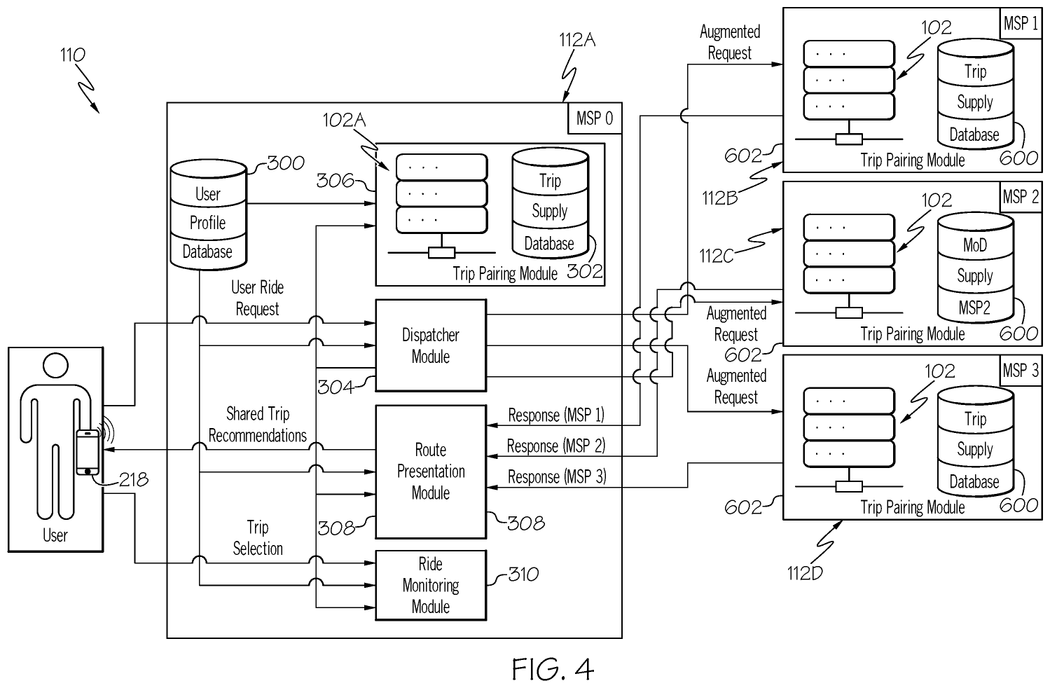

Now referring to FIG. 3, an exemplary controller 200 of the primary mobility service provider 112A is shown. The controller 200 includes a user profile database 300, a trip supply database 302, a dispatcher module 304, a trip pairing module 306, a route presentation module 308, and a ride monitoring module 310. With reference to FIGS. 3 and 4, the individual components of the controller 200 are schematically depicted in relation to the entire ride sharing system 110 along with the communication between the individual components illustrated.

The user profile database 300 includes user profiles for those users previously registered with the primary mobility service provider 112A. As discussed in more detail herein, the user profile for each user may include ride parameters that may have been previously selected by the user or learned over time based on previous user selections and experiences. The user profile for each user may include user preferences for future user ride requests such as, for example, efficiency requirements, personalization elements, and other requirements. With each subsequent use of the primary mobility service provider, the user profile for the particular user may be updated to reflect updated user preferences for that user.

The trip supply database 302 includes real time data on registered vehicles associated with the primary mobility service provider 112A such as, for example, vehicles that are currently unoccupied, vehicles that are currently occupied, and, for those vehicles that are currently occupied, destination information and occupant information. The real time data may be collected by the servers 102 illustrated in FIG. 1 that monitor the predefined geographic region 106. As discussed in more detail herein, the trip pairing module 306 utilizes this real time data of the vehicles associated with the primary mobility service provider 112A to identify one or more primary route recommendations to be presented to a user and displayed on the user device 218. It should be appreciated that the ride sharing system 110 discussed herein is particularly useful in matching a user ride request with a vehicle that may be occupied or is soon-to-be occupied. This provides efficient ride sharing in which one vehicle may be assigned multiple pick-up locations and multiple drop-off locations along a similar route.

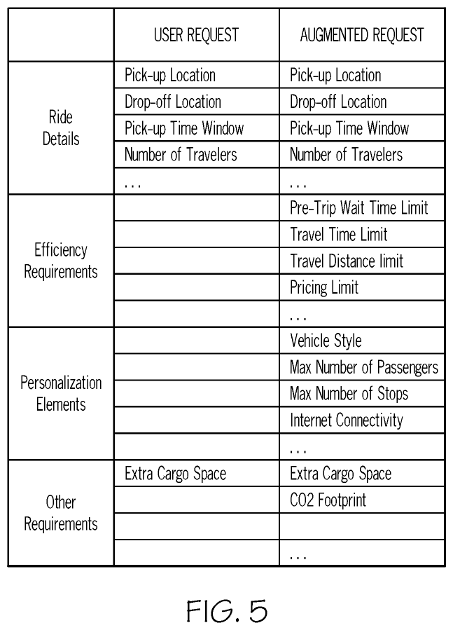

The dispatcher module 304 receives a user ride request from a user registered with the primary mobility service provider 112A. The user ride request includes ride details and, in some embodiments, other vehicle or trip requirements. Referring to FIG. 5, non-limiting examples of specific details of a user ride request are illustrated. As such, ride details may include a pick-up location, a drop-off location, a pick-up time window, and a number of travelers. A non-limiting example of other requirements may include extra cargo space. This information is extracted from the user ride request to identify route recommendations that meet the requirements and preferences associated with the user. Additionally, the dispatcher module 304 augments the user ride request with supplemental information such as, for example, additional ride details, efficiency requirements, personalization elements, and other vehicle and trip requirements, so that the trip pairing module 306 can provide the user with more personalized route recommendations specific to that user's ride preferences. Non-limiting examples of additional information that can be applied to augment the user ride request are indicated in the augmented request column. These additional pieces of information may be collected by previous selections of the user when creating the user profile and/or learned by previous trips taken by the user. As discussed herein, the user profile within the user profile database 300 may be updated after subsequent rides to update these user preferences for future use in matching the user with a particular route.

Referring again to FIGS. 3 and 4, the trip pairing module 306 of the primary mobility service provider 112A is configured to identify one or more primary route recommendations based on the available or soon-to-be available vehicles in the trip supply database 302 that can satisfy the requirements of the user ride request and, more particularly, the augmented user ride request. The trip pairing module 306 may identify a single primary route recommendation in instances in which there is a limited availability of registered vehicles or, alternatively, a plurality of primary route recommendations in instances in which demand is low.

The route presentation module 308 is configured to organize the one or more primary route recommendations identified by the trip pairing module 306 based on the details of the user ride request. The manner in which the route presentation module 308 presents the one or more primary route recommendations to the user may be in accordance with the user profile of the associated user. For example, the route presentation module 308 may rank the one or more primary route recommendations based on previously determined user preferences identified in the user profile, such as prioritizing routes having a shorter travel time. As described in more detail herein, the route presentation module 308 is also configured to organize and present one or more secondary route recommendations identified by the one or more secondary mobility service providers 112B-112D, along with the primary route recommendations. Thus, the user may be presented with a variety of route recommendations from not only the primary mobility service provider 112A, but also the secondary mobility service providers 112B-112D, such that the route recommendations are displayed on the user device 218.

The ride monitoring module 310 is configured to receive a ride selection from the user, via the user device 218, as to which of the route recommendations to execute. More particularly, the ride monitoring module 310 is configured to instruct the vehicle associated with the selected route recommendation to carry out the user ride request. Thereafter, the ride monitoring module 310 is configured to monitor the vehicle associated with the selected route recommendation to ensure that the route recommendation is completed in the manner instructed, i.e., the user is picked up at the correct location and dropped off at the correct destination within the determined time period.

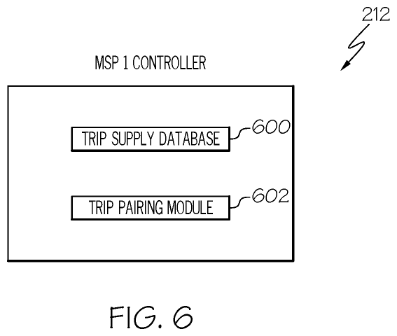

With respect now to the secondary mobility service providers 112B-112D, particularly secondary mobility service provider 112B, FIG. 6 illustrates an exemplary controller 212 of the secondary mobility service provider 112. Although only the controller 212 of the secondary mobility service provider 112B is illustrated, it should be appreciated that other secondary mobility service providers 112C, 112D may include the same components and operate in the same manner. As such, the components of the secondary mobility service providers 112B-112D are indicated in FIG. 4 using like reference numbers. As with the primary mobility service provider 112A, and with reference to FIGS. 4 and 6, each secondary mobility service provider 112B-112D includes a trip supply database 600 and a trip pairing module 602. The trip supply database 600 includes real time data on registered vehicles associated with the secondary mobility service providers 112B-112D such as, for example, vehicles that are currently unoccupied, vehicles that are currently occupied, and, for those vehicles that are currently occupied, destination information and occupant information. Accordingly, each secondary mobility service provider 112B-112D monitors the activity of its own supply of registered vehicles and registered users using the servers 102, which are assigned to a predefined geographic region 106 (FIG. 1). As discussed in more detail herein, the trip pairing module 602 utilizes this real time data to identify one or more secondary route recommendations to be displayed on the user device 218 based on the availability of vehicles registered with each of the secondary mobility service providers 112B-112D.

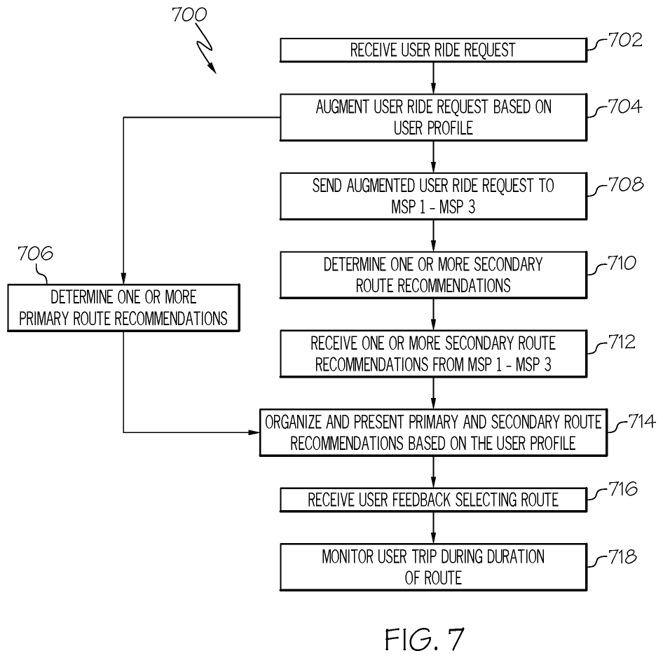

Referring now to FIG. 7, a method 700 is depicted for presenting a user with a plurality of route recommendations from a plurality of mobility service providers. The method 700 is discussed with reference to the ride sharing system 110 and individual components thereof illustrated in FIGS. 1-6.

At step 702, the primary mobility service provider 112A receives the user ride request 114 from a user via the user device 218. As discussed herein, the user ride request 114 includes ride details and, in some embodiments, other vehicle or trip requirements. At step 704, after the user ride request 114 is received at the dispatcher module 304 of the primary mobility service provider 112A, the dispatcher module 304 augments the user ride request 114 to include supplemental user-specific information such as, for example, vehicle driving efficiency requirements and personalization elements, as illustrated in FIG. 5.

At step 706, after the user ride request 114 is augmented, the trip pairing module 306 of the primary mobility service provider 112A identifies one or more vehicles in the trip supply database 302 that are registered with the primary mobility service provider 112A and capable of satisfying the requirements of the user ride request 114. After determining the primary route recommendations that satisfy the requirements of the user ride request 114, a hold is applied to the vehicles associated with those primary route recommendations to provide a predetermined period of time for the user to make a selection without the vehicles being selected by another user for another route. As such, the hold prevents other users from selecting a ride that requires use of the same vehicle. The predetermined period of time for which the hold is applied to the vehicles may be, for example, 30 seconds, 1 minute, 5 minutes, or the like.

At step 708, concurrently with determining the one or more primary route recommendations, the augmented user ride request is transmitted to each of the secondary mobility service providers 112B-112D. Upon the secondary mobility service providers 112B-112D receiving the augmented user ride request, each secondary mobility service provider 112B-112D determines one or more secondary route recommendations in a manner similar to that of the primary mobility service provider 112A. Specifically, at step 710, the trip pairing module 602 of each secondary mobility service provider 112B-112D matches the details of the augmented user ride request with those registered vehicles of the trip supply database 600 of each secondary mobility service provider 112B-112D that are available to satisfy the requirements of the augmented user ride request. Accordingly, the secondary mobility service providers 112B-112D determine one or more secondary route recommendations that satisfy the details of the augmented user ride request. After determining the secondary route recommendations, a hold is applied to the vehicles associated with the secondary route recommendations to provide a predetermined period of time for the user to make a selection without the vehicles being selected by another user, similar to the hold applied to vehicles associated with the primary route recommendations determined by the primary mobility service provider 112A.

In embodiments, some of the additional information utilized in augmenting the user ride request 114 to form the augmented user ride request is only made available to the primary mobility service provider 112A and, thus, withheld from the secondary mobility service providers 112B-112D. Accordingly, the primary mobility service provider 112A utilizes additional information not available to the secondary mobility service providers 112B-112D. Thus, the primary route recommendations determined by the primary mobility service provider 112A may be more accurately tailored to the preferences of the user than those secondary route recommendations determined by the secondary mobility service providers 112B-112D.

At step 712, the primary mobility service provider 112A receives the one or more secondary route recommendations determined by each of the secondary mobility service providers 112B-112D. It should be appreciated that, in embodiments, one or more of the secondary mobility services providers 112B-112D may not identify any suitable route recommendation when no vehicles within the predefined geographic region 106 of the user ride request 114 are available. Alternatively, the one or more of the secondary mobility service providers 112B-112D may identify a plurality of route recommendations when a plurality of vehicles are available within the geographic region 106.

At step 714, after the secondary route recommendations are received at the primary mobility service provider 112A, the primary mobility service provider 112A aggregates the primary route recommendations and the secondary route recommendations. The route presentation module 308 of the primary mobility service provider 112A then organizes the aggregated route recommendations in accordance with the preferences of the user profile. In embodiments, the route presentation module 308 organizes the total listing of primary route recommendations and the secondary route recommendations, such as by ranking, based on the preferences of the user profile. For example, certain user preferences, for example, trip travel time, may be weighted more heavily such that those route recommendations including those features or characteristics are prioritized for the user. The route presentation module 308 then transmits the organized listing of primary route recommendations and secondary route recommendations to the user device 218.

At step 716, the primary mobility service provider 112A receives user feedback including a route selection from the user device 218 identifying which of the primary route recommendations or the secondary route recommendations the user has selected. Accordingly, if the user selects one of the primary route recommendations, the primary mobility service provider 112A instructs the vehicle associated with the selected primary route recommendation to carry out the user ride request 114. Alternatively, if the user selects one of the secondary route recommendations, the primary mobility service provider 112A transmits an instruction to the associated secondary mobility service provider 112B, 112C, or 112D instructing the vehicle associated with the selected secondary route recommendation to carry out the user ride request.

At step 718, after the vehicle associated with the selected route recommendation is instructed to carry out the user ride request 114, the ride monitoring module 310 monitors the activity of the selected vehicle and, in some embodiments, the user device 218 to confirm that the user has been picked up by the selected vehicle at the user's location and dropped off at the intended destination.

From the above, it is to be appreciated that defined herein is a ride sharing system and method for presenting a user with a primary route recommendation and one or more secondary route recommendations received from different mobility service providers to provide a user with options as to which route to select. Accordingly, the user may be presented with a variety of route recommendations including vehicles registered with different mobility service providers to provide the user with routes that are tailored to the user's particular vehicle and ride preferences.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
receiving, from a user device, a user ride request at a primary mobility service provider, the primary mobility service provider monitoring activity of vehicles registered with the primary mobility service provider;
transmitting, by the primary mobility service provider, the user ride request to one or more secondary mobility service providers, each secondary mobility service provider monitoring activity of vehicles registered with the secondary mobility service provider;
identifying, by the primary mobility service provider, a primary route recommendation;
receiving, at the primary mobility service provider, one or more secondary route recommendations from the one or more secondary mobility service providers; and
presenting the primary route recommendation and the one or more secondary route recommendations to the user device.

2. The method of claim 1, wherein the primary mobility service provider and the one or more secondary mobility service providers each includes one or more servers for monitoring a predefined geographic region.

3. The method of claim 1, further comprising:
augmenting the user ride request to include supplemental information based on a user profile associated with the user device; and
transmitting, by the primary mobility service provider, the augmented user ride request to the one or more secondary mobility service providers.

4. The method of claim 3, wherein the augmented user ride request includes one or more user personalization elements and one or more vehicle driving efficiency requirements.

5. The method of claim 1, wherein presenting the primary route recommendation and the one or more secondary route recommendations to the user device further comprises:
organizing the primary route recommendation and the one or more secondary route recommendations in accordance with a user profile associated with the user device; and
displaying the primary route recommendation and the one or more secondary route recommendations in accordance with a user profile associated with the user device.

6. The method of claim 5, further comprising:
placing a hold on vehicles associated with the primary route recommendation and the one or more secondary route recommendations for a predetermined period of time such that the vehicles are not selected by another user device within the predetermined period of time.

7. The method of claim 1, further comprising:
receiving a route selection from the user device selecting a route from the primary route recommendation and the one or more secondary route recommendations to be executed by the primary mobility service provider.

8. The method of claim 7, further comprising:
identifying a vehicle associated with the selected route and registered with a secondary mobility service provider of the one or more secondary mobility service providers; and
transmitting instructions to the secondary mobility service provider to execute the selected route.

9. The method of claim 7, further comprising:
monitoring execution of the selected route until the user device arrives at a destination identified in the user ride request.

10. The method of claim 1, wherein the primary route recommendation and the one or more secondary route recommendations include routes shared by another user and including a destination other than a destination indicated in the user ride request.

11. A primary mobility service provider comprising:
a controller configured to:
monitor activity of vehicles registered with the primary mobility service provider;
receive, from a user device, a user ride request at the primary mobility service provider;
transmit the user ride request to one or more secondary mobility service providers, each secondary mobility service provider monitoring activity of vehicles registered with the secondary mobility service provider;
identify a primary route recommendation;
receive one or more secondary route recommendations from the one or more secondary mobility service providers; and
present the primary route recommendation and the one or more secondary route recommendations to the user device.

12. The primary mobility service provider of claim 11, wherein the primary mobility service provider and the one or more secondary mobility service providers each include one or more servers for monitoring a predefined geographic region.

13. The primary mobility service provider of claim 11, wherein the controller is further configured to:
augment the user ride request to include supplemental information based on a user profile associated with the user device; and
transmit the augmented user ride request to the one or more secondary mobility service providers.

14. The primary mobility service provider of claim 13, wherein the augmented user ride request includes one or more user personalization elements and one or more vehicle driving efficiency requirements.

15. The primary mobility service provider of claim 11, wherein the controller is further configured to:
organize the primary route recommendation and the one or more secondary route recommendations in accordance with a user profile associated with the user device; and
display the primary route recommendation and the one or more secondary route recommendations in accordance with a user profile associated with the user device.

16. The primary mobility service provider of claim 15, wherein the controller is further configured to:
place a hold on vehicles associated with the primary route recommendation and the one or more secondary route recommendations for a predetermined period of time such that the vehicles are not selected by another user device within the predetermined period of time.

17. The primary mobility service provider of claim 11, wherein the controller is further configured to:
receive a route selection from the user device selecting a route from the primary route recommendation and the one or more secondary route recommendations to be executed by the primary mobility service provider.

18. The primary mobility service provider of claim 17, wherein the controller is further configured to:
identify a vehicle associated with the selected route and registered with a secondary mobility service provider of the one or more secondary mobility service providers; and
transmit instructions to the secondary mobility service provider to execute the selected route.

19. The primary mobility service provider of claim 17, wherein the controller is further configured to:
monitor execution of the selected route until the user device arrives at a destination identified in the user ride request.

20. The primary mobility service provider of claim 11, wherein the primary route recommendation and the one or more secondary route recommendations may include routes shared by another user and including a destination other than a destination indicated in the user ride request.
